(19) United States
(12) Patent Application Publication
(10) Pub. No.: US 2009/0150248 A1
(43) Pub. Date: Jun. 11, 2009

(54) SYSTEM FOR ENHANCING PAYMENT SECURITY, METHOD THEREOF AND PAYMENT CENTER

(75) Inventors: Jin Ling, Beijing (CN); Qing Tao Sun, Beijing (CN); Yin Ben Xia, Beijing (CN); Zhe Xiang, Beijing (CN)

Correspondence Address: LEE LAW, PLLC;IBM CUSTOMER NUMBER, P.O. BOX 189, PITTSBORO, NC, 27312, US

(73) Assignee: INTERNATIONAL BUSINESS MACHINES CORPORATION, Armonk, NY (US)

(21) Appl. No.: 12/325,351

(22) Filed: Dec. 1, 2008

(30) Foreign Application Priority Data
Dec. 10, 2007 (CN) 200710196798.1

(51) Int. Cl. G06Q 20/00

(52) U.S. Cl. 705/17

(57) ABSTRACT

A system for enhancing payment security includes a payment network interface unit for communicating with a POS terminal through a payment network; a database for storing a card number and password of a payment tool of a user and a number of a mobile terminal of the user associated with the card number; an acquiring means for searching in the database to obtain the number of the user's mobile terminal associated with the card number; a receiving/sending unit for sending, according to the obtained number of the user's mobile terminal, a request for a transaction password of the payment tool to the user's mobile terminal by means of a wireless network; and an authentication means for authenticating whether or not the transaction password of the user's payment tool returned from the user's mobile terminal matches with the password stored in the database.

### RELATED APPLICATIONS

This application claims priority to and claims the benefit of Chinese Patent Application Serial No. 200710196798.1, which was filed in China on Dec. 10, 2007, and which is incorporated herein by reference in its entirety.

### BACKGROUND OF THE INVENTION

1. Technical Field of the Invention

The present invention relates generally to the security of a payment tool and relates in particular to a system and method for enhancing the payment security and a payment center for enhancing the payment security.

2. Related Art

Recently, it is increasingly popular for a user to make payments by a credit or debit card. In such a case, people can get many known advantages, for example, it is unnecessary for a user to carry a great amount of money, thereby to avoid the possibilities of the money being lost or stolen and free from troubles of giving charges for small-sum payment.

A card may be used in various ways, and the conventional way is to make a transaction through swiping (i.e., using) a card on a POS (Point of Sales) terminal. Recently, however, there are several new payment/collection operations and the dominant one is a mobile payment service. At present, the commercial mobile payment service is mainly divided into a virtual payment and a local POS operation.

The virtual payment means that a user can make a small-sum payment using his/her mobile phone by an operation based on mobile phones, such as a short message SMS. For, example, the user can send a SMS instruction to an issuer bank of the card used by the user, and then the issuer bank transfers the amount specified in the SMS from the user to the merchant's account. However, since this operation is not a secure operation, it only supports small-sum payments. In addition, the payee must be an authorized credible payee.

As for the local POS operation, the user uses a mobile phone instead of a credit/debit card. Generally, in such a case, a new SIM card needs to be inserted in the mobile phone of the user. Moreover, a new POS terminal needs to be replaced within shops. The POS terminal senses/recognizes the identity of the mobile phone by means of contact/non-contact technique (such as RFID (Radio Frequency Identification)). Except for using a mobile phone to substitute for a credit/debit card, other procedures are similar to the conventional procedures in which a POS terminal is used. As for such operation, the overall infrastructural cost is very high.

At present, in terms of the use of a credit/debit card, it is still dominant to implement a transaction by swiping the card on a POS terminal. In terms of such use, it generally can bring much convenience to users, only in the case where more and more shops allow the use of a credit/debit card. In practice, however, there exists a significant problem in promoting the card-based payment service, that is, users do not trust the merchants, especially, those merchants of small shops. This problem is particularly obvious in under-developed areas, because an overall credit system is not yet completely established in such areas.

For example, when a user purchases commodities in a small shop, he/she always worries about:

Whether the POS terminal in the shop is genuine or counterfeit? Is the POS terminal trustable?

Would the merchant secretly pirate the account and password of the card used by the user?

With such worries, the user usually will choose not to make payment by a credit/debit card but would rather pay with cash, so as to ensure the security of the credit/debit card.

FIG. 1 illustrates the procedures of implementing a payment through a POS terminal in prior art.

As shown in FIG. 1, the POS terminal 10 is connected to a payment center 12 through a payment network 14, wherein the payment center 12 can be an issuer bank of the card (such as a credit/debit card) used by a user and can store various information on the user and the card thereof (for example, the card number and the password). The payment network 14 can either be a dedicated line connecting the POS terminal 10 to the payment center 12, or other lines capable of making the communication between the POS terminal 10 and the payment center 12. In actual transactions, the POS terminal 10 reads the information on a magnetic strip of the card used by the user (such as the card number thereof) and transaction information (such as the transaction amount and the password of the card) can be input through a small keyboard on the POS terminal 10. Subsequently, the above information such as the card number, the transaction amount, and password of the card is sent to the payment center 12 through the payment network 14. The payment center 12 authenticates above information and confirms whether the transaction is successful. If it confirms to be successful, the payment center 12 returns a confirmation response to the POS terminal 10, and the POS terminal 10, in turn, prints bills, thereby to finish the transaction.

In addition, in the case where the POS terminal 10 is not directly associated with the payment center 12, that is, the POS terminal 10 is affiliated to another acquirer bank, the acquirer bank and a payment authorization institution that establishes a contact between the acquirer bank and the payment center 12 may be included in the payment network 14. In such a case, information on the card number, transaction amount, password of the card and the like is forwarded to the payment center 12 through the acquirer bank and the payment authorization institution.

It can be seen from the above payment procedures that, in the conventional POS terminal transaction procedures, the card number of the card used by the user is known to the POS terminal 10 and the password of the card is input through the small keyboard of the POS terminal 10. Consequently, merchants may illegally acquire the password of the card used by the user on the POS terminal 10 such that the card is no longer secure.

What is needed, therefore, is a system and method for improving payment security using a payment tool on a POS terminal, without modifying an existing POS terminal and a mobile terminal of a user.

### BRIEF SUMMARY OF THE INVENTION

In order to solve the technical problem discussed above, the present invention provides a system for enhancing the payment security, which comprises: a payment network interface unit for communicating with a POS terminal through a payment network; a database for storing a card number and password of a payment tool of a user and a number of a mobile terminal of the user associated with the card number; an acquiring means for searching in the database upon receiving the card number of the user's payment tool from the POS terminal through the payment network interface unit to obtain the number of the user's mobile terminal associated with the card number; a receiving/sending unit for sending, according to the number of the user's mobile terminal obtained by the acquiring means, a request for a transaction password of the payment tool to the user's mobile terminal by means of a wireless network; and an authentication means for authenticating, upon receiving the transaction password returned from the user's mobile terminal, whether or not the transaction password of the user's payment tool returned from the user's mobile terminal matches with the password of the user's payment tool which is stored in the database.

The present invention further provides a payment center for enhancing payment security, which comprises: a payment settlement means for receiving information on a transaction amount from the POS terminal through the payment network interface unit, and sending a message regarding settling the transaction to the POS terminal based on the information on the transaction amount and a result of whether the transaction password is matched.

The present invention provides a method for enhancing payment security, which comprises: receiving a card number of a payment tool of a user from a POS terminal through a payment network; acquiring a number of a mobile terminal of the user associated with the card number of the user's payment tool; sending, via a wireless network, a request for a transaction password of the payment tool to the user's mobile terminal according to the acquired number of the user's mobile terminal; and authenticating, upon receipt of a returned transaction password, whether or not the transaction password of the user's payment tool returned from the user's mobile terminal matches with a stored password of the user's payment tool which is stored in advance.

In addition, based on information on a transaction amount from the POS terminal and a result of whether the transaction password is matched, a response is sent regarding settling the transaction to the POS terminal.

According to the present invention, only the payment center (for example, the acquirer bank of the card used by the user on the POS terminal) is trustable, and it has all information on the user and the card used by the user. However, for the shops equipped with POS terminals and the telecom providers of a wireless network, obtaining both the card number and the password of the card used by the user may be prevented. Therefore, the present invention provides a significant improvement on the payment security.

The above and other objects, features and advantages of the invention will become apparent according to the following detailed description of the embodiments of the present invention in conjunction with the accompanying drawings.

### BRIEF DESCRIPTION OF THE SEVERAL VIEWS OF THE DRAWINGS

FIG. 1 shows a schematic view of a payment system using a POS terminal according to the prior art;

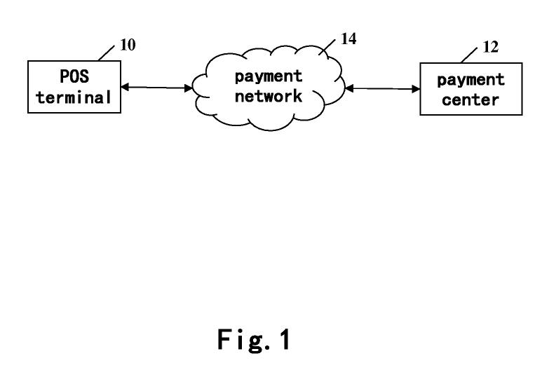

FIG. 2 shows a schematic view of a payment system with improved security using a POS terminal according to an embodiment of the present invention;

FIG. 3 is a functional block diagram showing the payment center according to an embodiment of the present invention; and

FIG. 4 is a flow chart showing the acquiring and authenticating process of a password performed by the payment center according to an embodiment of the present invention.

### DETAILED DESCRIPTION OF THE INVENTION

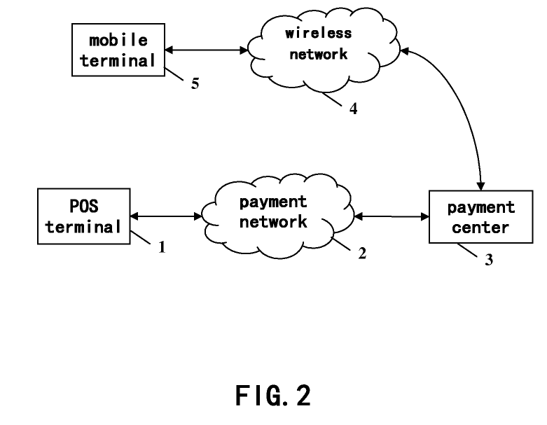

FIG. 2 shows a schematic view of a payment system with improved security using a POS terminal according to an embodiment of the present invention. As shown in FIG. 2, the payment system with improved security according to an embodiment of the present invention comprises: a POS terminal 1, a payment center 3, and a mobile terminal 5. The payment center 3 is connected to the POS terminal 1 through the payment network 2, and is connected to the mobile terminal 5 of a user through a wireless network 4.

The POS terminal 1 may be the various known POS terminal available in the market, as long as it can read a payment tool, for example the information of a magnetic strip on a credit/debit card, and can communicate with outside through the payment network 2. The payment network 2 is a network between the POS terminal 1 and the payment center 3, which can either be a dedicated line connecting the POS terminal 1 to the payment center 3, or other lines capable of making the communication between the POS terminal 1 and the payment center 3. In the case where the POS terminal 1 is not directly associated with the payment center 3, that is, the POS terminal 1 is affiliated to another acquirer bank, the acquirer bank and a payment authorization institution that establishes a contact between the acquirer bank and the payment center 3 may be included in the payment network 2. In such a case, information from the POS terminal 1, such as information on the card number, transaction amount, password of the card and the like is forwarded to the payment center 3 through the acquirer bank and the payment authorization institution. It is noted that, the present invention does not particularly limit the form of the payment network 2, as long as it can make the communication between the POS terminal 1 and the payment center 3.

The payment center 3 may communicate with the POS terminal 1 through the payment network 2, thereby to obtain information on the user's payment tool (credit/debit card, etc.) transmitted from the POS terminal 1, such as information on the card number and transaction amount. For a user of a credit/debit card, the payment center 3 may be the issuer bank of the credit/debit card of the user. The payment center 3 also stores information relevant to the user and the card used by the user. For the user, the payment center 3 is completely trustable, the detailed structures of which will be described later. It is noted that, the payment tool used by the user is not limited to a credit/debit card, but may be any card in various forms, provided the payment tool used by the user is authorized by the payment center 3 and may be used on the POS terminal 1. Hereinafter, the payment tool used by the user on the POS terminal 1 is referred to as card.

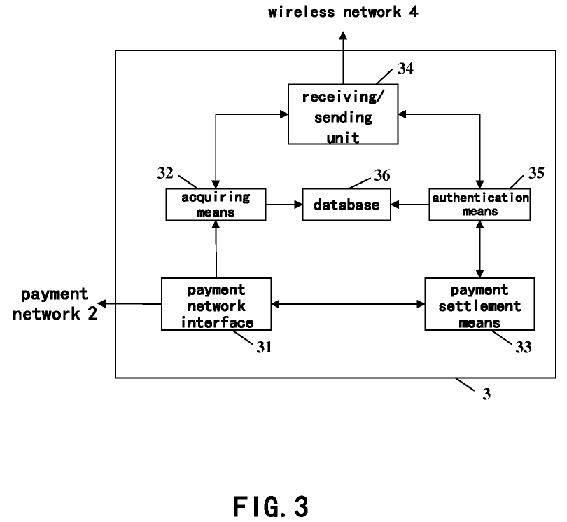

It is assumed that, in the following description of the present invention, the card used by the user on the POS terminal 1 is a card already subscribed in the payment center 3, that is, the card used by the user, such as a credit/debit card, is already associated with the number of the user's mobile terminal 5 (hereinafter the card is called as a subscribed card), and the user has subscribed the service of finishing the transaction on the POS terminal 1 by the password provided through the mobile terminal 5 of the user. The information on the user and the subscribed card of the user has been stored in the payment center 3, for example, in a database 36 (See FIG. 3) of the payment center 3. The mobile terminal 5 of the user may be a mobile phone with a function of receiving/sending short messages, such as SMS (short messages) or USSD (unstructured supplementary service data). However, it should be understood that, the present invention does not limit the mobile terminal 5 which may be any mobile device, provided it supports the message forms transmitted by the payment center 3.

Upon receiving the information on the card number of the card used by the user on the POS terminal 1 and its transaction amount from the POS terminal 1, the payment center 3 obtains the number of user's mobile terminal 5 associated with the card number based on the card and sends a short message to the number through the wireless network 4, such as SMS or USSD (it has been ensured that user's mobile terminal 5 has the function of receiving and sending such messages). The wireless network 4 may be any wireless network supported by the mobile provider. The sent short message may ask a request for returning the password of the card used by the user on the POS terminal 1, but without containing the card number or only showing part of the card number. Generally, this short message is sent to the user's mobile terminal 5 in a very short time after the user swipes his/her card on the POS terminal 1. The user must have already subscribed this service. Therefore, in such a case, the user may know the card indicated in the short message and thus may return the correct password corresponding to the card. Alternatively, the short message may indicate the last several numbers of the card number used by the user on the POS terminal 1 and the amount consumed by the user using the card on the POS terminal 1. For enhancing the security of the card, the first several numbers of the card number may not be displayed directly but may be replaced with such signs as “*”, for example, a card number of eleven numbers may be displayed as “*******1234”. The payment center 3 may authenticate the returned password and determine whether the password is correct after receiving the password of the card sent back by the user using the user mobile terminal 5, for example, by comparing the returned password of the card with the password of the card stored in advance in the payment center 3 to determine whether the two match with each other. The sequent process proceeds if it is determined the authentication result is correct, by determining whether the balance is enough for the payment and whether it exceeds the up limit for overdraft, and returning a response of whether the payment center 3 confirms the transaction to the POS terminal 1 based on the determined result. The POS terminal 1 performs corresponding process according to the response returned from the payment center 3 through the payment network 2, for example, performing bill printing if the returned response confirms the transaction, or informing the user that the transaction cannot be committed if the returned response refuses the transaction.

Alternatively, if the payment center 3 sends a short message asking a request for returning the password of the card used by the user on the POS terminal 1 but the user refuses to provide the password in the returned short message, the payment center 3 then deems that the user refuses the transaction, and returns a response of refusing the transaction to the POS terminal 1.

Alternatively, if the payment center 3 sends a short message asking a request for returning the password of the card used by the user on the POS terminal 1 but receives no message from the user for a predetermined period of time, the payment center 3 then deems that the user refuses the transaction, and returns a response of refusing the transaction to the POS terminal 1, wherein the predetermined period of time may be set by the payment center 3 in advance.

Referring to FIG. 3, the components of the payment center 3 in accordance with an embodiment of the present invention will be described below.

As shown in FIG. 3, the payment center 3 in accordance with an embodiment of the present invention comprises a payment network interface unit 31, an acquiring means 32, a payment settlement means 33, a receiving/sending unit 34, an authentication means 35 and a database 36.

The payment network interface unit 31 communicates with the POS terminal 1 through the payment network 2, and transmits the information on the card number of the card used by the user on the POS terminal 1 from the POS terminal 1 to the acquiring means 32 and the information on the amount consumed by the user using the card to the payment settlement means 33.

After receiving the information on the card number of the card used by the user from the POS terminal 1 through the payment network interface unit 31, the acquiring means 32 searches in the database 36 of the payment center 3 to acquire the number of the user's mobile terminal 5 associated with the card. The information associated with the user and the card subscribed by the user is stored in advance in the database 36, comprising the card number of the card subscribed by the user, the number of user's mobile terminal 5 associated with the subscribed card, the current balance of the subscribed card, and the usage limits of authority (such as the up limit of the amount that can be consumed) or the like.

After the acquiring means 32 has acquired the number of user's mobile terminal 5 associated with the subscribed card, the number of user's mobile terminal 5 is transmitted to the receiving/sending unit 34. The receiving/sending unit 34 sends a short message to user's mobile terminal 5 requesting for returning the password of the card used by the user on the POS terminal 1. The short message may not contain the card number of the card or shows part digits of the card number. Generally, this short message is sent to user's mobile terminal 5 in a very short time after the user swiped his/her card on the POS terminal 1, and the user must have already subscribed this service. Therefore, in such a case, the user may know the card indicated in the short message and thus may return the correct password corresponding to the card. Alternatively, the short message may indicate part numbers of the card number used by the user on the POS terminal 1 (such as the last several numbers) and the amount consumed by the user using the card. For enhancing the security of the card, the first several numbers of the card number may not be displayed directly but may be replaced with such signs as “*”, for example, a card number of eleven numbers may be displayed as “*******1234”.

The receiving/sending unit 34 receives the short message returned from user's mobile terminal 5 including the password and transmits the password of the card to the authentication means 35, wherein the password of the card used by the user on the POS terminal 1 is provided in the returned short message. The authentication means 35 authenticates the returned password to determine whether the returned password is correct, for example by comparing the returned password with the password of the subscribed card that is stored in advance in the database 36 to determine whether the two match with each other. Such comparison may be accomplished for example by a comparator (not shown). After the authentication, the authentication means 35 transmits the authentication result to the payment settlement means 33.

Alternatively, if the receiving/sending unit 34 sends a short message asking a request for returning the password of the card used by the user on the POS terminal 1 but the user refuses to provide the password in the returned short message, the authentication means 35 then deems that the user refuses the transaction, thereby to directly transmits the result of user refusing to provide the password (equivalent to that the password is not correct) to the payment settlement means 33.

Alternatively, if the receiving/sending unit 34 sends a short message asking a request for returning the password of the card used by the user on the POS terminal 1 but receives no message from the user for a predetermined period of time, the authentication means 35 then deems that the user refuses the transaction, and transmits the result of user refusing to provide the password (equivalent to that the password is not correct) to the payment settlement means 33. In such a case, the payment center 3 in accordance with the present invention further comprises a time counter (not shown), and the predetermined period of time may be set in advance.

Based on the information on transaction amount received from the POS terminal 1 through the payment network interface unit 31 and the result of password authentication from the authentication means 35, with reference to the information associated with the card used by the user in the database 36 (such as the balance in the card, the up limit for overdraft or the like), the payment settlement means 33 sends a response regarding settling the transaction to the POS terminal 1 through the receiving/sending unit 34. If the password authentication result from the authentication means 35 shows the password is not correct or the user refuses to provide the password, then the response of refusing the transaction is returned to the POS terminal 1.

Although in FIG. 3, it is shown that the payment network interface unit 31 transmits the information on the card number of the card used by the user on the POS terminal 1 from the POS terminal 1 to the acquiring means 32 and the information on the amount consumed by the user to the payment settlement means 33, alternatively, both the information on the card number of the card used by the user on the POS terminal 1 and the information on the amount consumed by the user from the POS terminal 1 may be transmitted to the acquiring means 32. After acquiring the number of user's mobile terminal 5 associated with the card, the acquiring means 32 may transmit the information on the amount consumed by the user to the payment settlement means 33, and the number of user's mobile terminal 5 associated with the card to the receiving/sending unit 34 respectively.

Each individual component described in FIG. 3 may be achieved by ways of hardware, software or the combination thereof, provided they may accomplish the functions of the above individual component. No special requirements or limits are imposed on its component structure.

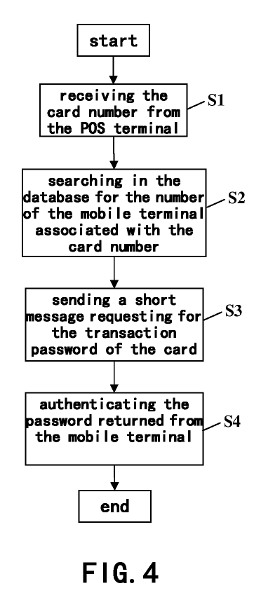

FIG. 4 is a flow chart showing the password acquiring and authenticating process performed by the payment center 3 according to an embodiment of the present invention. Referring to FIG. 4, the password acquiring and authenticating process performed by the payment center 3 according to the present invention is described below.

In step S1, the payment network interface unit 31 receives the information on the card number of the card used by the user from the POS terminal 1 and transmits the information on the card number to the acquiring means 32. Then, the process proceeds to step S2.

In step S2, the acquiring means 32 searches in the database 36 of the payment center 3 to obtain the number of user's mobile terminal 5 associated with the card used by the user in accordance with the information on the card number of the card used by the user from the POS terminal 1, and transmits the number to the receiving/sending unit 34. Then, the process proceeds to step S3.

In step S3, the receiving/sending unit 34 sends a short message requesting for returning the transaction password of the card used by the user on the POS terminal 1 to user's mobile terminal 5 based on the card number. Then, the process proceeds to step S4.

In step S4, the authentication means 35 authenticates the password returned from user's mobile terminal 5 and received by the receiving/sending unit 34 so as to determine whether the password is correct. The authentication may be executed by comparing the returned password with the password of the card stored in the database 36 in advance to determine whether the two match with each other.

The security of payment made by using the card such as a credit card or a debit card on the POS terminal 1 may be improved through above steps. In the above process, the shops equipped with POS terminals may be prevented from knowing the card number of the card used by a user on a POS terminal and the password thereof, as well as the telecom providers who provide a wireless network, thereby significantly enhancing the security for payment using a card.

The above embodiments according to the present invention are described in the case where the card used on the POS terminal 1 is assumed to have been subscribed with the payment center 3 already. In the case where it is unknown whether the card used on the POS terminal 1 has been already subscribed with the payment center 3, the payment center 3 may first determine whether the card is a subscribed card based on the card number, that is, whether the user's card has been associated with the number of the user's mobile terminal 5 and whether the user has subscribed the service of providing password using the mobile terminal 5 of the user, when receiving the information on the card number and transaction amount of the card used by the user on the POS terminal 1 from the POS terminal 1. If the payment center 3 determines the card is not a subscribed card, then it performs a procedure for acquiring the password of a card by conventional ways instead of using the mobile terminal 5 of the user. If the payment center 3 determines the card is a subscribed card, then it obtains the number of user's mobile terminal 5 associated with the card according to the card number and sends a short message, such as SMS or USSD to the number for requesting the password of the card (user's mobile terminal 5 is ensured to have the function of receiving and sending such short messages).

Specifically, in above situation, although not shown in FIG. 3, it is possible to verify the user's subscription state by a verification means before the payment network interface unit 31 transmits the information on the card number used by the user on the POS terminal 1 from the POS terminal 1 to the acquiring means 32 and the information on the amount consumed by the user using the card to the payment settlement means 33. That is to say, the payment network interface unit 31 transmits the information on the card number used by the user on the POS terminal 1 to the verification means. For example, the verification means may determine whether the card is a subscribed card by searching the database 36 and comparing with a check up table that stores card numbers of all subscribed cards in advance in the database 36. If the verification means determines the card is not a subscribed card, it then transmits directly the information from the POS terminal 1 to the payment settlement means 33 and the procedures for acquiring the password at the POS terminal 1 is performed instead of using the mobile terminal 5 of the user. If the verification means determines the card is a subscribed card, it then transmits the information on the card number of the card used by the user on the POS terminal 1 from the POS terminal 1 to the acquiring means 32 and the information on the amount consumed by the user to the payment settlement means 33. The subsequent processing is similar to that described with reference to FIG. 3 and thus is omitted.

According to the above embodiments of the present invention, there is no need to make any modification to the original POS terminals. It is also unnecessary for the user to enter the password of the card on the POS terminal 1 when making a business deal using a credit/debit card in a small shop equipped with a POS terminal. The POS terminal 1 only transmits the card number of the card used by the user and the transaction amount to the payment center 3, such as the issuer bank of the card. Therefore, the password of the card used by the user may be prevented from being obtained by the shop.

After receiving the card number from the POS terminal 1, the payment center 3 may obtain the number of the user's mobile terminal 5 (such as a mobile phone) associated with the card number by searching the database 36 and requests to the password from the user of the card used by the user on the POS terminal 1 in a form of short message or the like through the wireless network 4 provided by the telecom providers, wherein the short message may include both part of the card number (such as the last several digits of the number) and the consumed amount but not show the complete card number. When receiving the password request, the user may return the password of the card by short message or refuse to provide the password if he/she intends to give up the transaction or finds out the transaction amount is incorrect. Therefore, in above process, only the password of the card used by the user and part of the card number thereof, if used, are transmitted through the wireless network 4. The card number of the card used by the user and the password thereof may be prevented from being given away simultaneously through the wireless network 4 provided by the telecom provider. In addition, the number of the user's mobile terminal 5 is unknown to the shops equipped with POS terminals, which further enhances the security of payment using a payment tool such as a credit/debit card in small shops equipped with POS terminals.

In the entire procedures according to the embodiments of the present invention, only the payment center 3 (such as the issuer bank of the card used by the user) is trustable and has all the information on the user and the card used by the user. For those shops equipped with POS terminals and the telecom providers of the wireless network 4, they may be prevented from simultaneously obtaining the card number of the card used by the user and the password thereof, not to mention simultaneously obtaining the card number of the card used by the user, the password thereof and the number of the user's mobile terminal 5. Therefore, the present invention provides great improvement to the payment security.

Although in the above embodiments, the descriptions are directed to a credit/debit card, those skilled in the art should appreciate that the payment tools adopted by the user are not limited to a credit card of a debit card but may be cards of various forms, provided the payment tool used by the user is authorized by the payment center 3 and may be used on the POS terminal 1. Although in the above embodiments, the communication between the payment center 3 and the mobile terminal 5 of the user is described in term of SMS and the USSD, those skilled in the art should also appreciate that any message that may be transmitted through a wireless network may be adopted, provided both the payment center 3 and the mobile terminal 5 of the user support the receiving and sending of such messages. Furthermore, those skilled in the art should appreciate that the mobile terminal 5 of the user is not limited to a mobile phone but may be any mobile devices, provided it supports the form of the message transmitted by the payment center 3.

While particular embodiments of the present invention have been shown and described, it will be obvious to those skilled in the art that various changes and modifications to the embodiments are conceivable. Therefore, the present invention encompasses all modifications and replacements within the patent scope of protection as defined in the appended claims.

What is claimed is:

1. A system for enhancing payment security, comprising:
a payment network interface unit for communicating with a POS terminal through a payment network;
a database for storing a card number and password of a payment tool of a user and a number of a mobile terminal of the user associated with the card number;
an acquiring means for searching in the database upon receiving the card number of the user's payment tool from the POS terminal through the payment network interface unit to obtain the number of the user's mobile terminal associated with the card number;
a receiving/sending unit for sending, according to the number of the user's mobile terminal obtained by the acquiring means, a request for a transaction password of the payment tool to the user's mobile terminal by means of a wireless network; and
an authentication means for authenticating, upon receiving the transaction password returned from the user's mobile terminal, whether or not the transaction password of the user's payment tool returned from the user's mobile terminal matches with the password of the user's payment tool stored in the database.

2. The system for enhancing payment security according to claim 1, where sending the request for the transaction password of the payment tool to the user's mobile terminal further comprises sending at least one of a short message SMS and an unstructured supplementary service data (USSD).

3. The system for enhancing payment security according to claim 1, where the user's mobile terminal is a mobile phone.

4. The system for enhancing payment security according to claim 1, further comprising:
a payment center for enhancing payment security, comprising:
a payment settlement means for receiving information on a transaction amount from the POS terminal through the payment network interface unit, and sending a message regarding settling the transaction to the POS terminal based on the information on the transaction amount and a result of whether the transaction password is matched.

5. The system for enhancing payment security according to claim 4, where the request for the transaction password of the payment tool sent to the user's mobile terminal comprises information on the transaction amount.

6. The system for enhancing payment security according to claim 4, where the user's payment tool is a payment device selected from a group consisting of a credit card and a debit card.

7. The system for enhancing payment security according to claim 6, where the payment center comprises an issuer bank of the user's payment tool.

8. The system for enhancing payment security according to claim 4, where the communication between the receiving/sending unit and the user's mobile terminal further comprises sending at least one of a short message SMS and an unstructured supplementary service data (USSD).

9. The system for enhancing payment security according to claim 4, where the user's mobile terminal is a mobile phone.

10. The system for enhancing payment security according to claim 4, where the payment center comprises at least one of an acquirer bank and a payment authorization institution.

11. The system for enhancing payment security according to claim 4, further comprising a verification means for verifying whether or not the payment tool used by the user on the POS terminal is a payment tool subscribed in the payment center.

12. A method for enhancing payment security, comprising:
receiving a card number of a payment tool of a user from a POS terminal through a payment network;
acquiring a number of a mobile terminal of the user associated with the card number of the user's payment tool;
sending, via a wireless network, a request for a transaction password of the payment tool to the user's mobile terminal according to the acquired number of the user's mobile terminal; and
authenticating, upon receipt of a returned transaction password, whether or not the transaction password of the user's payment tool returned from the user's mobile terminal matches with a stored password of the user's payment tool which is stored in advance.

13. The method for enhancing payment security according to claim 12, further comprising:
sending a response regarding settling a transaction to the POS terminal based on information on a transaction amount from the POS terminal and a result of whether the transaction password is matched.

14. The method for enhancing payment security according to claim 12, where sending the request for the transaction password of the payment tool to the user's mobile terminal further comprises sending at least one of a short message SMS and an unstructured supplementary service data (USSD).

15. The method for enhancing payment security according to claim 12, where the user's mobile terminal is a mobile phone.

16. The method for enhancing payment security according to claim 12, where the request for the transaction password of the payment tool sent to the user's mobile terminal comprises information on a transaction amount.

17. The method for enhancing payment security according to claim 12, where the user's payment tool is a payment device selected from a group consisting a credit card and a debit card.

18. The method for enhancing payment security according to claim 12, where authenticating whether or not the transaction password of the user's payment tool returned from the user's mobile terminal matches with the stored password of the user's payment tool which is stored in advance further comprises authenticating the transaction password via a payment center comprising an issuer bank of the user's payment tool.

19. The method for enhancing payment security according to claim 12, where authenticating whether or not the transaction password of the user's payment tool returned from the user's mobile terminal matches with the stored password of the user's payment tool which is stored in advance further comprises authenticating the password via a payment centre comprising at least one of an acquirer bank and a payment authorization institution.

20. The method for enhancing payment security according to claim 12, further comprising verifying whether or not the payment tool used by the user on the POS terminal is a subscribed payment tool.
